(19) United States
(12) Patent Application Publication
(10) Pub. No.: US 2026/0225769 A1
(43) Pub. Date: Aug. 6, 2026

(54) SCREW CAP

(71) Applicant: HONDA MOTOR CO., LTD., Tokyo (JP)

(72) Inventors: Kaz Hayashi, Dublin, OH (US); Jessica L Vera, Dublin, OH (US)

(73) Assignee: HONDA MOTOR CO., LTD., Tokyo (JP)

(21) Appl. No.: 19/039,024

(22) Filed: Jan. 28, 2025

(51) Int. Cl. B65D 41/04; B29C 33/20; B29L 31/56

(52) U.S. Cl. CPC B65D 41/04; B29C 33/20; B29L 2031/56

(57) ABSTRACT

A screw cap comprises a top surface; and a side surface continuously extending downward from the top surface. The side surface comprises a tapered surface tapered toward a bottom of the screw cap such that a width of the screw cap is tapered toward the bottom of the screw cap.

### BACKGROUND

### Technical Field

The present disclosure relates to a screw cap including, for example, a fuel tank lid.

### Related Art

A screw cap is used for closing an opening by screwing. For example, a fuel tank lid is used for closing, for example, an opening of a fuel tank through which refueling is conducted.

### SUMMARY

In one aspect of the present disclosure, a screw cap comprises:

a top surface; and

a side surface continuously extending downward from the top surface,

wherein the side surface comprises a tapered surface tapered toward a bottom of the cap such that a width of the cap is tapered toward the bottom of the cap.

### BRIEF DESCRIPTION OF THE DRAWINGS

The advantages of the disclosure will become apparent in the following description taken in conjunction with the following drawings.

FIG. 1 is a perspective view of a fuel tank lid according to the first embodiment of the present disclosure.

FIG. 2 is another perspective view of a fuel tank lid according to the first embodiment of the present disclosure.

FIG. 3 is another perspective view of a fuel tank lid according to the first embodiment of the present disclosure.

FIG. 4 is a schematic view of a fuel tank lid according to the first embodiment of the present disclosure.

FIG. 5 is a schematic plan view of a fuel tank lid according to the first embodiment of the present disclosure.

FIG. 6 is a schematic side perspective view of a fuel tank lid according to the first embodiment of the present disclosure.

FIG. 7 is a side view of a fuel tank lid according to the second embodiment of the present disclosure.

FIG. 8 is a side view of a fuel tank lid according to a variation of the second embodiment of the present disclosure.

FIG. 9 is a schematic plan view of a fuel tank lid according to the second embodiment of the present disclosure.

FIG. 10 is a flow chart showing processes of manufacturing a fuel tank lid according to the present disclosure.

FIG. 11 is a schematic sectional view of a mold frame according to the embodiment of the present disclosure.

FIG. 12 is a schematic side view describing position of a boundary of a pair of mold frames upper edge.

FIG. 13 is a schematic side view describing position of a boundary of a pair of mold frames upper edge.

FIG. 14 is a schematic side view describing position of a boundary of a pair of mold frames upper edge.

### DESCRIPTION OF EXEMPLARY EMBODIMENTS

Hereinafter, the present disclosure will be described through embodiments, but the following embodiments do not limit the invention according to the claims. In addition, not all combinations of features described in the embodiments are essential to the solution of the invention. Hereinafter, like elements are described by using like reference numerals and repetitive description of like elements employed in one or more embodiments described herein is omitted. In the following descriptions, a fuel tank lid is used as an example of a screw cap. However, the present disclosure is not limited to the fuel tank lid. For example, the screw cap may be applied to other screw cap such as a radiator cap.

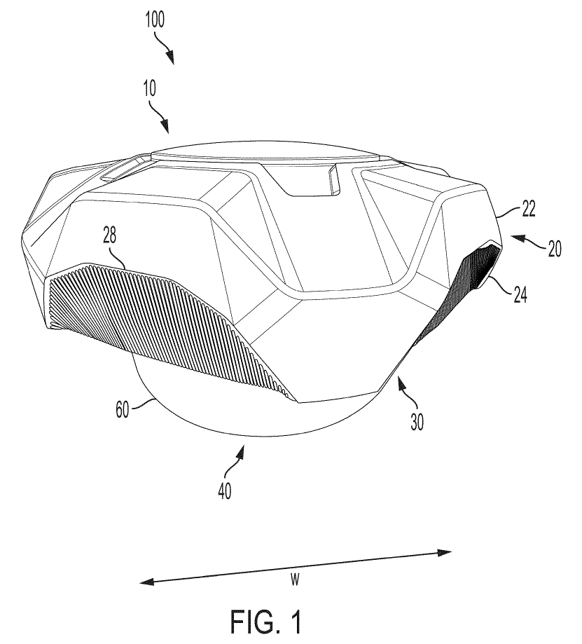

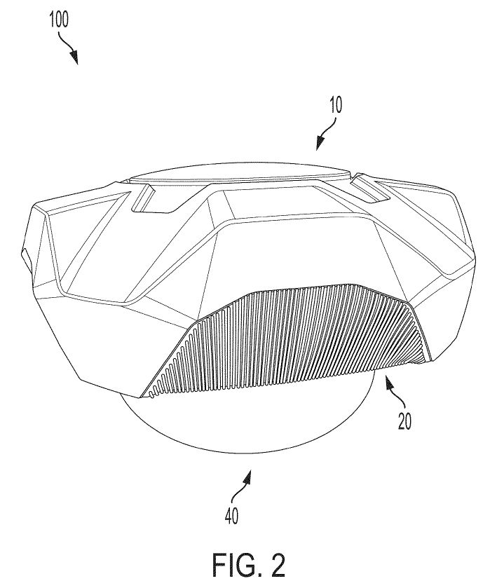

A fuel tank lid according to the first embodiment of the present disclosure is described below. FIG. 1 is a perspective view of a fuel tank lid according to the first embodiment of the present disclosure. FIG. 2 is another perspective view of a fuel tank lid according to the first embodiment in a different view angle.

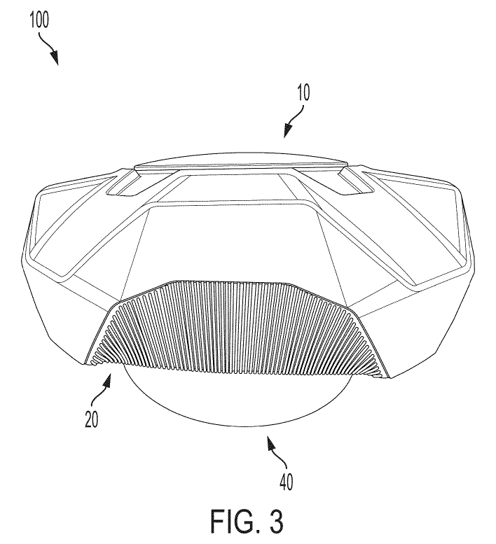

FIG. 3 is another perspective view of a fuel tank lid according to the first embodiment in a different view angle.

As shown by FIGS. 1-3, a fuel tank lid 100 comprises a top surface 10 and a side surface 20 continuously extending downward from the top surface 10. The side surface comprises a tapered surface 24 tapered toward a bottom 40 of the lid 100 such that a width W of the lid 100 is tapered toward the bottom 40 of the lid 100. The fuel tank lid 100 includes a leg 60 which is inserted into an opening of a fuel tank. However, the leg 60 may be omitted.

As shown by FIGS. 1-3, an upper edge 28 of the tapered surface 24 is located at an intermediate portion of the side surface 20 in an up-and-down direction. The side surface 20 comprises an upper side surface 22. The upper side surface 22 may be a vertical surface, or an inclined surface inclined outward such that the width W of the lid 100 is widened toward the bottom 40 of the lid 100. The upper edge 28 of the tapered surface 24 is disposed at a lower end of the upper side surface 22 such that the tapered surface 24 is continuous from the upper side surface 22 with an angled corner therebetween. The embodiment is not limited to this structure. For example, the corner between the upper side surface 22 and the tapered surface 24 may be a curved corner.

The upper side surface 22 may be also a tapered surface tapered toward the bottom 40 of the lid 100 such that the width W of the lid 100 is tapered toward the bottom 40 of the lid 100. In this configuration, the tapering angle of the upper side surface 22 may be different from the tapering angle of the tapered surface 24.

According to the configuration described above, the tapered surface which is constructed as described above may ease gripping by a hand of a user.

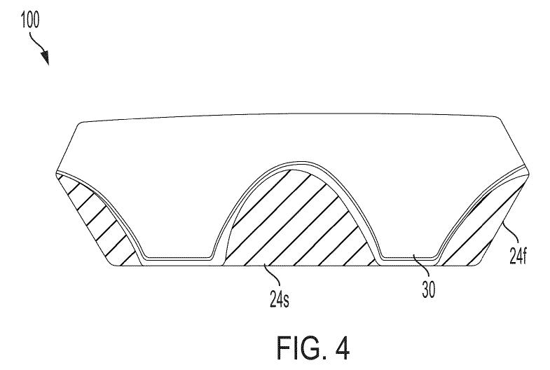

FIG. 4 is a schematic view of a fuel tank lid according to the first embodiment of the present disclosure. As shown by FIG. 4, the tapered surface 24 comprises a plurality of tapered surfaces 24 comprising a first tapered surface 24f and a second tapered surface 24s adjacent to each other in a circumferential direction of the lid 100 having an intervening side surface 30 therebetween. In this embodiment, the intervening side surface 30 may be a vertical surface, or an inclined surface inclined outward such that the width of the lid 100 is widened toward the bottom 40 of the lid 100.

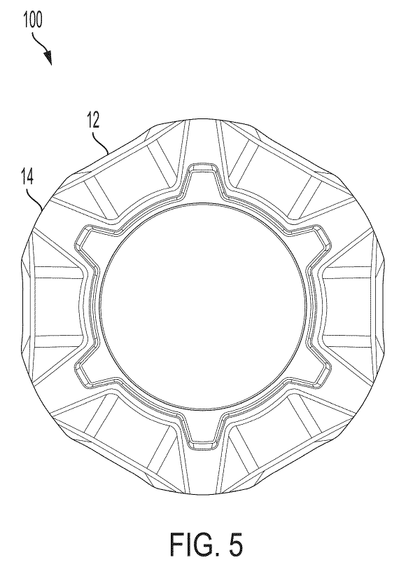

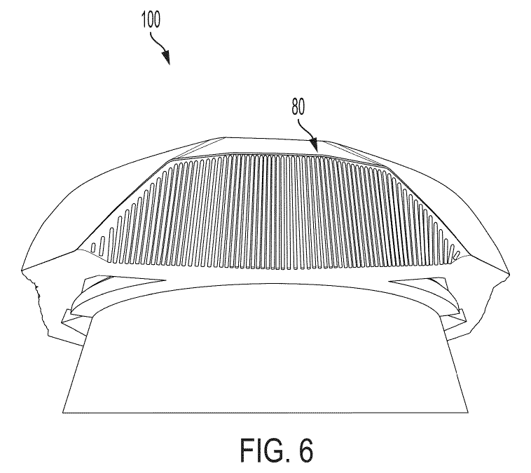

FIG. 5 is a schematic plan view of a fuel tank lid according to the first embodiment of the present disclosure. As shown by FIG. 5, a circumference of the lid 100 includes a recessed portion 12 recessed inward in a plan view of the lid 100, and the tapered surface 24 is disposed in the recessed portion 12. In this configuration, the tapered surface 24 constitutes a grip portion of the lid 100 and includes a plurality of vertical grooves 80 thereon as shown by FIG. 6.

According to the configuration described above, the tapered surface which is constructed as described above may ease gripping by a hand and fingers of a user and may facilitate rotation of the fuel tank lid when closing or opening the lid by engagement of the fingers with the recessed portion 12 and the grooves 80.

### Second Embodiment

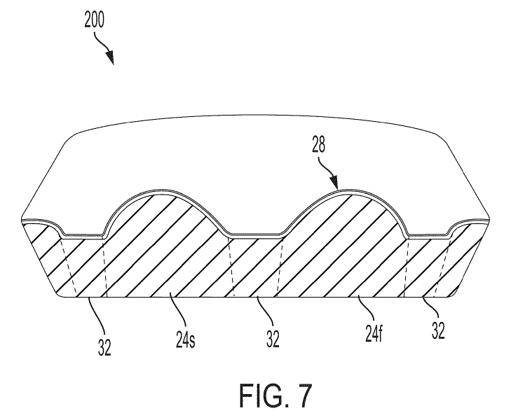

FIG. 7 is a side view of a fuel tank lid according to the second embodiment of the present disclosure. In the second embodiment, the configuration of the intervening side surface 32 is different from the configuration of the intervening side surface 30. As shown by FIG. 7, the tapered surface 24 comprises a plurality of tapered surfaces 24 comprising a first tapered surface 24f and a second tapered surface 24s adjacent to each other in a circumferential direction of the lid 200 having an intervening side surface 32 therebetween. In this embodiment, the intervening side surface 32 is a third tapered surface having a tapered angle which is different from the tapered angle of the first tapered surface 24f and the tapered angle of the second tapered surface 24s. For example, the tapered angle of the third tapered surface may be smaller than the tapered angle of the first tapered surface 24f and the tapered angle of the second tapered surface 24s In this embodiment, the tapered surfaces 24f, 24s and 32 together surround a circumference of the lid 200 entirely.

As shown by FIG. 7, the upper edge 28 of the tapered surfaces surrounds an entire circumference of the lid 200, and the upper edge 28 of the tapered surfaces is entirely located in an intermediate portion of the side surface 20 in the up-and-down direction. Moreover, the height of the upper edge 28 of the tapered surfaces from the bottom of the lid 200 varies along a circumferential direction of the lid 200. For example, the upper edge 28 of the tapered surfaces forms a wave-shaped outline in a side view of the lid 200.

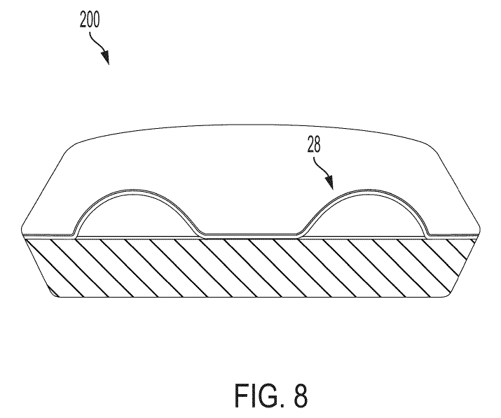

FIG. 8 is a side view of a fuel tank lid according to a variation of the second embodiment of the present disclosure. The configuration of the fuel tank lid is not limited to the above-described second embodiment. For example, as a variation, the upper edge 28 of the tapered surfaces may form a straight outline in a side view of the lid 200.

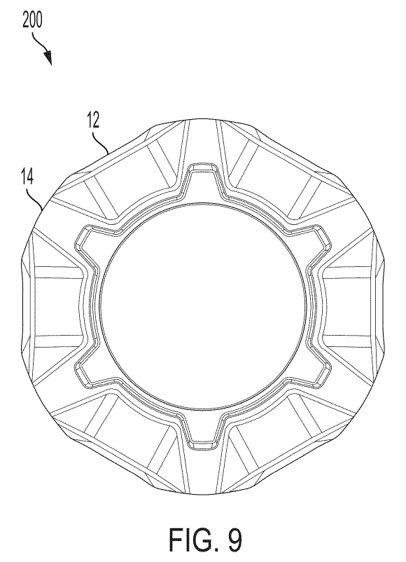

FIG. 9 is a schematic plan view of a fuel tank lid according to the second embodiment of the present disclosure. As shown by FIG. 9, a circumference of the lid 200 includes a recessed portion 12 recessed inward in a plan view of the lid 200 and a protruding portion 14 protruding outward relative to the recessed portion 12 in the plan view of the lid 200. For example, the tapered surface 24f, 24s is disposed in the recessed portion 12. The tapered surface 32 is disposed in the protruding portion 14.

### Manufacturing method

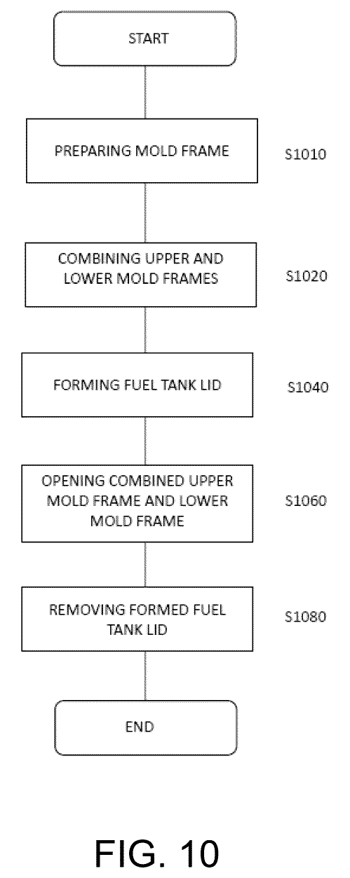

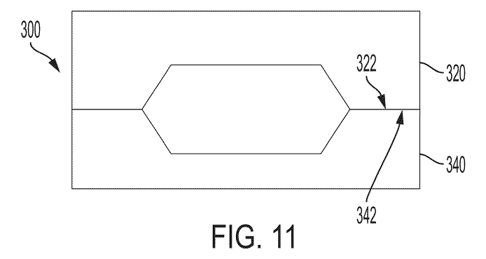

Now, a method of manufacturing a fuel tank lid is described. FIG. 10 is a flow chart showing processes of manufacturing a fuel tank lid according to the present disclosure. At step S1010, a mold frame comprising an upper mold frame and a lower mold frame is prepared. FIG. 11 is a schematic sectional view of a mold frame according to the embodiment of the present disclosure. As shown by FIG. 11, the mold frame 300 comprises a pair of sub mold frames, that is, the upper mold frame 320 and the lower mold frame 340. Each of the upper mold frame 320 and the lower mold frame 340 includes own cavity or dent to create a space inside thereof.

Then, at step S1020, the upper mold frame 320 and the lower mold frame 340 are combined together such that a bottom surface 322 of the upper mold frame 320 abuts against a top surface 342 of the lower mold frame 340. When the upper mold frame 320 and the lower mold frame 340 are combined together, the cavities thereof form a space which conforms to the outline of the fuel tank lid 100 or 200.

Then, at step S1040, the fuel tank lid 100 or 200 is formed by introducing a plastic material into the space generated in the combined upper mold frame 320 and lower mold frame 340. In this step, a boundary between the abutting bottom surface 322 of the upper mold frame 320 and the top surface 342 of the lower mold frame 340 is aligned with the upper edge 28 of the tapered surface 24 of the lid 100 or 200 in a side view of the lid.

Then, at step S1060, the combined upper mold frame 320 and lower mold frame 340 are opened to separate one from the other. Then, at step S1080, thus formed fuel tank lid is removed from the lower mold frame 340 or the upper mold frame 320.

Because the boundary between the abutting bottom surface 322 of the upper mold frame 320 and the top surface 342 of the lower mold frame 340 is aligned with the upper edge 28 of the tapered surface 24 of the lid 100 or 200 in a side view of the lid, it is facilitated to remove the formed fuel tank lid 100 or 200.

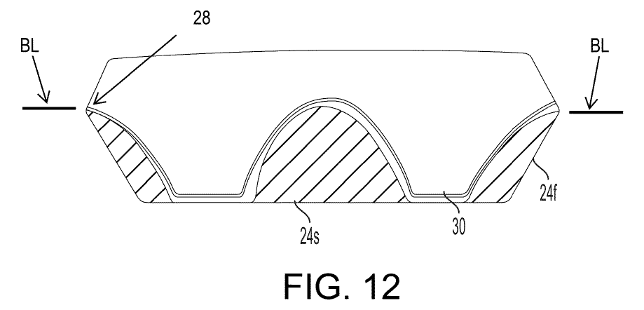

FIG. 12 is a schematic side view describing position of a boundary of a pair of mold frames upper edge. Similar to the first embodiment, the side surface comprises an upper side surface which is a vertical surface, or an inclined surface inclined outward such that the width of the lid is widened toward the bottom of the lid. The upper edge of the tapered surface is disposed at a lower end of the upper side surface such that the tapered surface is continuous from the upper side surface with an angled corner therebetween. The boundary BL between the abutting bottom surface of the upper mold frame and the top surface of the lower mold frame is aligned with the upper edge 28 of the tapered surface.

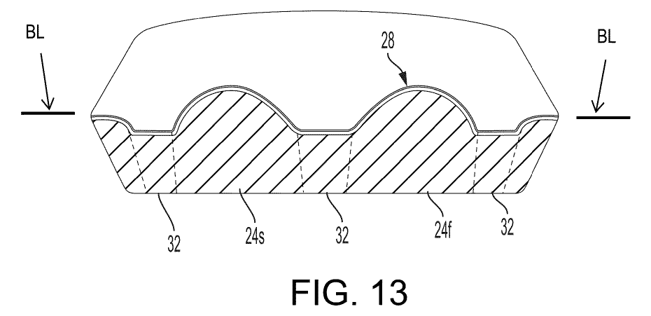

FIG. 13 is a schematic side view describing position of a boundary of a pair of mold frames upper edge. Similar to the second embodiment, the tapered surface surrounds a circumference of the lid entirely. The upper edge of the tapered surface surrounds an entire circumference of the lid, and the upper edge of the tapered surface is entirely located in an intermediate portion of the side surface in the up-and-down direction. The upper edge of the tapered surface forms a wave-shaped outline in a side view of the lid. The boundary BL between the abutting bottom surface of the upper mold frame and the top surface of the lower mold frame is aligned with the upper edge 28 of the tapered surface.

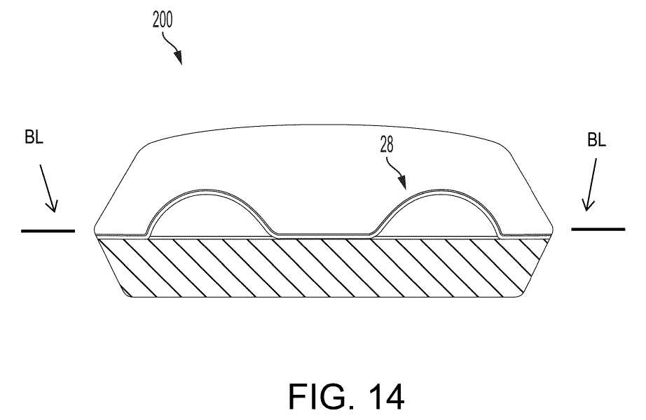

FIG. 14 is a schematic side view describing position of a boundary of a pair of mold frames upper edge. The upper edge 28 of the tapered surface forms a straight outline in a side view of the lid. The boundary BL between the abutting bottom surface of the upper mold frame and the top surface of the lower mold frame is aligned with the upper edge 28 of the tapered surface.

Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

What is claimed is:

1. A screw cap comprises:
a top surface; and
a side surface continuously extending downward from the top surface,
wherein the side surface comprises a tapered surface tapered toward a bottom of the screw cap such that a width of the screw cap is tapered toward the bottom of the screw cap.

2. The screw cap according to claim 1, wherein an upper edge of the tapered surface is located at an intermediate portion of the side surface in an up-and-down direction.

3. The screw cap according to claim 1, wherein the tapered surface surrounds a circumference of the screw cap entirely.

4. The screw cap according to claim 1, wherein the tapered surface comprises a plurality of tapered surfaces comprising a first tapered surface and a second tapered surface adjacent to each other in a circumferential direction of the screw cap having an intervening side surface therebetween, and
wherein the intervening side surface is a vertical surface, or an inclined surface inclined outward such that the width of the screw cap is widened toward the bottom of the screw cap.

5. The screw cap according to claim 3, wherein the tapered surface comprises a plurality of tapered surfaces comprising a first tapered surface and a second tapered surface adjacent to each other in a circumferential direction of the screw cap having an intervening side surface therebetween, and
wherein the intervening side surface is a third tapered surface having a tapered angle which is different from the tapered angle of the first tapered surface and the tapered angle of the second tapered surface.

6. The screw cap according to claim 2, wherein the side surface comprises an upper side surface which is a vertical surface, or an inclined surface inclined outward such that the width of the screw cap is widened toward the bottom of the screw cap, and
wherein the upper edge of the tapered surface is disposed at a lower end of the upper side surface such that the tapered surface is continuous from the upper side surface with an angled corner therebetween.

7. The screw cap according to claim 3, wherein a height of the upper edge of the tapered surface from the bottom of the screw cap varies along a circumferential direction of the screw cap.

8. The screw cap according to claim 3, wherein the upper edge of the tapered surface surrounds an entire circumference of the screw cap, and the upper edge of the tapered surface is entirely located in an intermediate portion of the side surface in the up-and-down direction.

9. The screw cap according to claim 8, wherein the upper edge of the tapered surface forms a wave-shaped outline in a side view of the screw cap.

10. The screw cap according to claim 8, wherein the upper edge of the tapered surface forms a straight outline in a side view of the screw cap.

11. The screw cap according to claim 1, wherein a circumference of the screw cap includes a recessed portion recessed inward in a plan view of the screw cap, and the tapered surface is disposed in the recessed portion.

12. The screw cap according to claim 11, wherein the tapered surface constitutes a grip portion of the screw cap and includes a plurality of grooves thereon.

13. The screw cap according to claim 11, wherein the circumference of the screw cap includes a protruding portion protruding outward relative to the recessed portion in the plan view of the screw cap, and the tapered surface is disposed in the protruding portion.

14. A method of manufacturing a screw cap,
wherein the screw cap comprises:
a top surface; and
a side surface continuously extending downward from the top surface,
wherein the side surface comprises a tapered surface tapered toward a bottom of the screw cap such that a width of the screw cap is tapered toward the bottom of the screw cap,
wherein an upper edge of the tapered surface is located at an intermediate portion of the side surface in an up-and-down direction,
the method comprising:
preparing a mold frame comprising an upper mold frame and a lower mold frame;
combining the upper mold frame and the lower mold frame together such that a bottom surface of the upper mold frame abuts against a top surface of the lower mold frame;
forming the screw cap by introducing a plastic material into a space in the combined upper mold frame and lower mold frame,
wherein the space has a shape conforming to the screw cap; and
wherein a boundary between the abutting bottom surface of the upper mold frame and the top surface of the lower mold frame is aligned with the upper edge of the tapered surface of the screw cap in a side view of the screw cap; and
opening the combined upper mold frame and lower mold frame.

15. The method according to claim 14, wherein the side surface comprises an upper side surface which is a vertical surface, or an inclined surface inclined outward such that the width of the screw cap is widened toward the bottom of the screw cap, and
wherein the upper edge of the tapered surface is disposed at a lower end of the upper side surface such that the tapered surface is continuous from the upper side surface with an angled corner therebetween.

16. The method according to claim 14, wherein the tapered surface comprises a plurality of tapered surfaces comprising a first tapered surface and a second tapered surface adjacent to each other in a circumferential direction of the screw cap having an intervening side surface therebetween,
wherein the intervening side surface is a vertical surface, or an inclined surface inclined outward such that the width of the screw cap is widened toward the bottom of the screw cap,
wherein the boundary between the abutting bottom surface of the upper mold frame and the top surface of the lower mold frame is aligned with the upper edge of the first tapered surface, the upper edge of the second tapered surface, or both of the upper edge of the first tapered surface and the upper edge of the second tapered surface in the side view of the screw cap.

17. The method according to claim 14, wherein the tapered surface surrounds a circumference of the screw cap entirely, and
wherein the upper edge of the tapered surface surrounds an entire circumference of the screw cap, and the upper edge of the tapered surface is entirely located in an intermediate portion of the side surface in the up-and-down direction.

18. The screw cap according to claim 1, wherein the screw cap is a fuel tank lid.

19. The method according to claim 14, wherein the screw cap is a fuel tank lid.

20. A mold frame configured to manufacture a screw cap, comprising:
an upper mold frame including an upper cavity inside thereof; and
a lower mold frame including a lower cavity inside thereof,
wherein the upper mold frame and the lower mold frame are configured to abut each other such that the upper cavity faces the lower cavity, and a bottom surface of the upper mold frame abuts against a top surface of the lower mold frame,
wherein the lower cavity includes a side surface comprising a tapered surface tapered toward a bottom of the lower cavity such that a width of the lower cavity is tapered toward the bottom of the lower cavity, and
wherein a boundary between the abutting bottom surface of the upper mold frame and the top surface of the lower mold frame is aligned with an upper edge of the tapered surface of the lower cavity in a side view of the mold frame.
